(19) United States
(12) Patent Application Publication
(10) Pub. No.: US 2026/0311712 A1
(43) Pub. Date: Oct. 8, 2026

(54) DISFLUENCY REMOVAL VIA A NEURAL NETWORK AUDIO CODEC SYSTEM

(71) Applicant: Cisco Technology, Inc., San Jose, CA (US)

(72) Inventors: Radhakrishna Shri Venkata Achanta, Vallorbe (CH); Pawel Podolski, Wroclaw (PL); Rafal Pilarczyk, Plock (PL)

(21) Appl. No.: 19/170,162

(22) Filed: Apr. 4, 2025

(51) Int. Cl. G10L 19/038; G10L 25/51

(52) U.S. Cl. CPC G10L 19/038; G10L 25/51

(57) ABSTRACT

Techniques are provided for removing disfluent speech from an input audio stream via a neural network audio encoder/decoder (codec) system. In one embodiment, a method includes obtaining an input audio stream to be encoded by an audio encoder of a neural network audio codec system, encoding, via the audio encoder, the input audio stream to generate one or more embedding vectors, and quantizing, via a vector quantizer, the one or more embedding vectors to generate one or more quantized vectors each comprising a plurality of codes. The method further includes removing, via a disfluency removal function, from each of the one or more quantized vectors a subset of the plurality of codes corresponding to disfluent speech to generate one or more modified quantized vectors and decoding, via an audio decoder, the one or more modified quantized vectors to reconstruct the input audio stream without the disfluent speech.

### TECHNICAL FIELD

The present disclosure relates to removing disfluency from an audio stream via a neural network audio codec system.

### BACKGROUND

Disfluent speech such as filler words (e.g., “um,” “err,” “ah,” “you know,” etc.) or long pauses can make live or recorded speech sound unprofessional or unpleasant to follow depending on the fluency of the speaker and the sensibilities of the listener. Moreover, disfluency in audio streams may hinder effective communication between the speaker and the listener, thus significantly diminishing the user experience of both the speaker and the listener. For example, a user listening to recorded speech content (or message) may find it difficult to understand and/or enjoy the speech because the speaker often uses filler words such as “ah,” “um,” and “basically.” The disfluency issue is even more noticeable when the user listens to the recording at an accelerated speed. Based on the unpleasant listening experience, the user may form a poor opinion of the speaker who is otherwise considered an expert. Thus, there is a need to effectively remove disfluency from speech so that the listener can better engage with the content and connect with the speaker.

### BRIEF DESCRIPTION OF THE DRAWINGS

FIG. 1 is a block diagram illustrating a neural network audio codec system configured to replace disfluent speech codes with replacement speech codes or silence codes, according to one example embodiment.

FIG. 2 is a block diagram illustrating a processing flow for classifying a speech code for purposes of removing disfluency speech according to the techniques shown in FIG. 1, according to another example embodiment.

FIG. 3 is a block diagram illustrating a neural network audio codec system configured to remove disfluent speech codes, according to another example embodiment.

FIG. 4 is a block diagram illustrating a processing flow for classifying a speech code for the purposes of removing disfluency speech according to the techniques shown in FIG. 3, according to another example embodiment.

FIG. 5 is a block diagram illustrating a neural network audio codec system configured to remove disfluency speech, according to still another example embodiment.

FIG. 6 is a flow diagram illustrating a method for removing disfluent speech from an input audio stream, according to an example embodiment.

FIG. 7 is a hardware block diagram of a computing device that may perform functions associated with operations discussed herein in connection with the techniques depicted.

### DETAILED DESCRIPTION

### Overview

Techniques are provided for removing disfluent speech from an input audio stream via a neural network audio encoder/decoder (codec) system. In one embodiment, a method includes obtaining an input audio stream to be encoded by an audio encoder of a neural network audio codec system that includes the audio encoder, a vector quantizer, a disfluency removal function, and an audio decoder. The method includes, encoding, via the audio encoder, the input audio stream to generate one or more embedding vectors, and quantizing, via the vector quantizer, the one or more embedding vectors to generate one or more quantized vectors each comprising a plurality of codes. The method further includes removing, via the disfluency removal function, from each of the one or more quantized vectors a subset of the plurality of codes corresponding to disfluent speech to generate one or more modified quantized vectors and decoding, via the audio decoder, the one or more modified quantized vectors to reconstruct the input audio stream without the disfluent speech.

### Example Embodiments

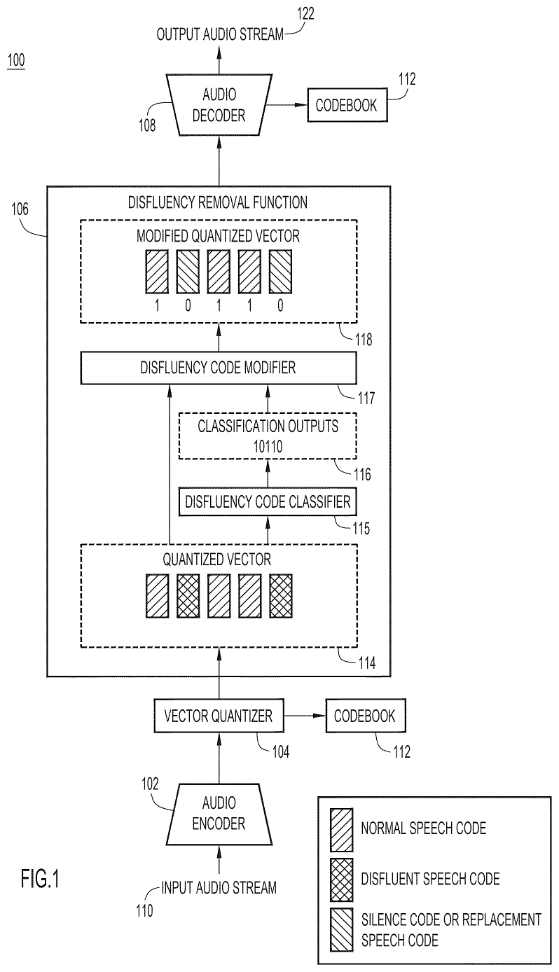

Reference is first made to FIG. 1, for a description of a block diagram illustrating a neural network audio encoder/decoder (codec) system 100, according to an example embodiment. The neural network audio codec system 100 includes an audio encoder 102, a vector quantizer 104, a disfluency removal function 106, and an audio decoder 108. In certain embodiments, the audio encoder 102, the vector quantizer 104, and the audio decoder 108 are part of a Vector Quantized Variational Autoencoder.

The audio encoder 102 receives an input audio stream 110 that includes speech as well as artifacts and/or impairments. For example, the input audio stream 110 may be obtained from an audio recording, a video stream (that includes audio), and/or any suitable source. In one example, the input audio stream 110 may be obtained from recordings of audio and/or video meetings on a collaboration platform. The input audio stream 110 includes one or more frames each corresponding to a predetermined duration of speech (e.g., 10 or 20 milliseconds). Each of the one or more frames may correspond to normal speech or disfluent speech. Normal speech includes a smooth or continuous flow of speech without prolonged pauses or interruptions. Disfluent speech includes one or more filler words (e.g., ‘um’, ‘err’, ‘ah’, ‘you know’), one or more filler syllables of one or more words, a predetermined duration of silence, repetition of sounds, syllables, or words within a predetermined duration, or any other types of speech irregularities indicative of disfluency. In certain embodiments, one or more categories of disfluent speech can be determined by a subject matter expert (e.g., language expert, speech therapist, etc.).

In certain embodiments, the input audio stream 110 may include a combination of normal speech and disfluent speech. The audio encoder 102 encodes the input audio stream 110 to generate one or more embedding vectors including data that represents the important/meaningful features or relationships (e.g., temporal dependencies and/or patterns) of the input audio stream 110. For example, the audio encoder 102 may include a deep neural network that transforms the input audio stream 110 frame-by-frame into one or more embedding vectors that keep the important features and optionally removing the artifacts and/or impairments. In certain embodiments, the audio encoder 102 may encode the input audio stream 110 in a streaming fashion (e.g., via stream processing).

The audio encoder 102 may include a deep neural network composed of convolutional, recurrent, attentional, pooling, activation, fully connected neural layers, or any suitable nonlinearities and normalization. The deep neural network may also include one or more rectified linear units (ReLU), residual units, and/or softmax functions. In certain embodiments, the audio encoder 102 may include a hybrid deep neural network that is a combination of two or more deep neural networks. The audio encoder 102 may be trained, optimized, and/or fine-tuned via any suitable technique (e.g., supervised or unsupervised learning, transfer learning, reinforcement learning, etc.).

The vector quantizer 104 quantizes the one or more embedding vectors at the output of the audio encoder 102. The vector quantizer 104 may quantize the one or more embedding vectors (e.g., high-dimensional embeddings vectors) by mapping the one or more embedding vectors into a set of codewords from a codebook 112 using one or more quantization techniques. In certain embodiments, the vector quantizer 104 may be a single-layered vector quantizer (e.g., using a single codebook) or a multi-layered vector quantizer (e.g., using a plurality of codebooks) implementing one or more quantization techniques. For example, the one or more quantization techniques can include residual vector quantization, scalar quantization, product quantization, or any suitable vector quantization technique. The vector quantizer 104 provides as output one or more quantized vectors (e.g., a quantized vector 114) that include one or more codewords (e.g., discrete codes) that map to the one or more embedding vectors. By compressing the one or more embedding vectors into one or more quantized vectors of codewords, the vector quantizer 104 reduces the dimensionality of the one or more embedding vectors. Thus, the one or more quantized vectors may also be referred to as compact or compressed speech vectors. In certain embodiments, the audio encoder 102 may generate the one or more quantized vectors directly without the need for a separate vector quantizer 104.

Each code (e.g., neural code) in the one or more quantized vectors corresponds to a frame of speech in the input audio stream 110. For example, each code in the quantized vector 114 is a code corresponding to a frame of normal speech (e.g., “normal speech code”) or a code corresponding to a frame of disfluent speech (e.g., “disfluent speech code”). The one or more quantized vectors (e.g., quantized vector 114) are provided as input to the disfluency removal function 106. The disfluency removal function 106 includes a disfluency code classifier 115 configured to generate one or more classification outputs 116 each classifying a code as corresponding to normal speech or disfluent speech, and further includes a disfluency code modifier 117 configured to replace one or more codes corresponding to disfluent speech. The disfluency code classifier 115 can be implemented via a neural network (e.g., feed-forward deep neural network, convolutional neural network, recurrent neural network, etc.), a support vector machine, a transformer-based model (e.g., large language model), a hybrid model including multiple machine learning models, or any suitable machine learning model. The disfluency code classifier 115 may be trained, optimized, and/or fine-tuned via any suitable technique (e.g., supervised or unsupervised learning, transfer learning, reinforcement learning, etc.).

The disfluency code classifier 115 is configured to classify each code in the one or more quantized vectors as a normal speech code or a disfluent speech code. In certain embodiments, the disfluency code classifier 115 determines a probability for each code in the one or more quantized vectors as being disfluent speech or normal speech. Then, the disfluency code classifier 115 compares the probability associated with the code to a predetermined threshold. If the probability exceeds a threshold, the disfluency code classifier 115 assigns a normal speech label (e.g., “1”) to the code. However, if the probability does not exceed the threshold, the disfluency code classifier 115 assigns a disfluent speech label (e.g., “0”) to the code. The threshold can be adjusted based on user requirement and/or feedback. The labels (e.g., “1” for normal speech label or “0” for disfluent speech label) corresponding to the one or more codes may be provided as the one or more classification outputs 116 to the disfluency code modifier 117. In certain embodiments, the one or more classification outputs 116 may include probability values corresponding to the one or more codes in the one or more quantized vectors as being disfluent speech or normal speech.

The one or more classification outputs 116 and the one or more quantized vectors (e.g., the quantized vector 114) are provided as inputs to the disfluency code modifier 117. Based on the one or more classification outputs 116, the disfluency code modifier 117 is configured to replace each code in the one or more quantized vectors (e.g., the quantized vector 114) having the disfluent speech label (e.g., codes with the “0” label) with a code corresponding to silence (“silence code”) or a code corresponding to a replacement speech (“replacement speech code”). For example, a silence code may correspond to a predetermined duration of silence (e.g., a frame of silence in an input audio stream). A replacement speech code may correspond to a frame of replacement speech (e.g., normal speech), which may include a stretched version of one or more previous words or syllables in the input audio stream 110. For example, the replacement speech includes at least one normal word immediately preceding a word of the disfluent speech that is being replaced. Moreover, the replacement speech may be speech content having the same meaning and duration as the disfluent speech that is being replaced. The disfluency code modifier 117 is configured to replace one or more disfluent speech codes in the one or more quantized vectors (e.g., the quantized vector 114) with silence codes or normal speech codes to generate one or more modified quantized vectors (e.g., a modified quantized vector 118) without any disfluent speech codes.

For example, the input audio stream 110 may include speech for the sentence “We will discuss the report with your . . . um . . . team.” The disfluency code classifier 115 may classify the code corresponding to the speech “um” as a disfluent speech code and the disfluency code modifier 117 may replace that code with a silence code or a replacement speech code. Thus, the disfluent speech (e.g., “um”) is replaced with silence or replacement speech (e.g., normal speech). In one example, replacing “um” with silence produces speech for the sentence “We will discuss the report with your [silence] team.” In another example, replacing “um” with a normal speech (e.g., the word “legal”) produces speech for the sentence “We will discuss the report with your legal team.”

The one or more modified quantized vectors are provided as input to the audio decoder 108. The audio decoder 108 is configured to decode the discrete codes in the one or more modified quantized vectors using the codebook 112 and to reconstruct the input audio stream 110 without the disfluent speech. That is, for example, the audio decoder 108 is configured to generate an output audio stream 122 (e.g., the reconstructed input audio stream) that includes speech without disfluencies. In certain embodiments, the audio decoder 108 may generate the output audio stream 122 in a streaming fashion (e.g., via stream processing). In certain embodiments, instead of the codebook 112, the audio decoder 108 may use a different codebook, such as a codebook that includes all of the data in the codebook 112 and additional data suitable for decoding purposes.

In certain embodiments, the audio decoder 108 is configured to detect that two or more consecutive codes in a modified quantized vector (e.g., modified quantized vector 118) are the same, thus indicating the speech corresponding to those codes are stretched across two or more frames. Thus, the audio decoder 108 is configured to generate a smooth and continuous stretched audio output in those frames to mimic natural speech patterns without speech disfluencies. The output audio stream 122 may be provided as output to a user (e.g., via a user interface), a database, etc. Therefore, the neural network audio codec system 100 can be leveraged to improve the speech quality of audio outputs, thereby providing a positive listening experience for the user.

The audio decoder 108 may include a deep neural network composed of convolutional, recurrent, attentional, pooling, activation, fully connected neural layers, or any suitable nonlinearities and normalization. The deep neural network may also include one or more rectified linear units (ReLU), residual units, and/or softmax functions. In certain embodiments, the audio decoder 108 may include a hybrid deep neural network that is a combination of two or more deep neural networks. The audio decoder 108 may be trained, optimized, and/or fine-tuned via any suitable technique (e.g., supervised or unsupervised learning, transfer learning, reinforcement learning, etc.).

In certain embodiments, the audio encoder 102, the disfluency code classifier 115, and the audio decoder 108 are trained together in an end-to-end manner to remove speech disfluencies from an input audio stream (e.g., input audio stream 110). In certain embodiments, the disfluency code classifier 115 may be trained separately from the audio encoder 102 and the audio decoder 108 (e.g., an encoder-decoder pair). In these embodiments, the discrete codes (e.g., neural codes) and corresponding labels used by the audio encoder 102 and the audio decoder 108 may be known to the disfluency code classifier 115 prior to training, thus making it easier to label each code as corresponding to normal speech or disfluency. In some examples, the disfluency code classifier 115 may be trained after the audio encoder 102 and the audio decoder 108 are trained.

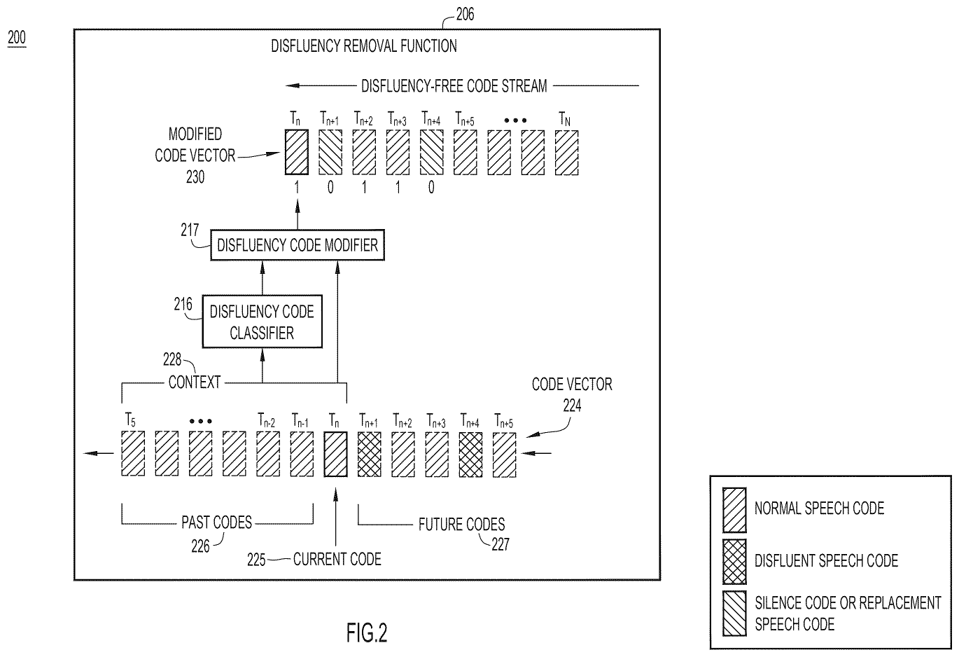

Reference is now made to FIG. 2, for a description of a block diagram illustrating a processing flow 200 for classifying a speech code as disfluent speech and replacing it with a replacement speech code or silence code as depicted by the system shown in FIG. 1, but now in more detail, according to an example embodiment. The processing flow 200 includes operations performed by a disfluency removal function 206 configured to classify a code as corresponding to normal speech or disfluent speech and/or remove one or more codes corresponding to disfluent speech. The disfluency removal function 206 includes operations performed by a disfluency code classifier 216 and a disfluency code modifier 217. The disfluency code classifier 216 takes as input a code vector 224 (e.g., a quantized vector) having a plurality of codes (e.g., neural codes) each corresponding to a frame of speech from an input audio stream. For example, a code may correspond to a frame of normal speech (e.g., “normal speech code”) or to a frame of disfluent speech (e.g., “disfluent speech code”). Each frame may be a predetermined duration of speech (e.g., 10 or 20 milliseconds). In certain embodiments, the code vector 224 may be generated by a vector quantizer (e.g., vector quantizer 104) configured to map one or more embedding vectors representing an input audio stream to one or more quantized vectors of discrete codes.

For example, the code vector 224 includes a plurality of codes each corresponding to a frame of speech at time T of the input audio stream. For example, the code vector 224 may contain a current code 225 corresponding to a current timestamp Tₙ, a plurality of past codes 226 corresponding to past timestamps Tₙ₋₁, Tₙ₋₂, Tₙ₋₃, Tₙ₋₄, Tₙ₋₅, . . . , T_{S}, and a plurality of future codes 227 corresponding to future timestamps Tₙ₊₁, Tₙ₊₂, Tₙ₊₃, Tₙ₊₄, Tₙ₊₅, . . . , T_{N}, where n denotes a current timestamp of the input audio stream, S denotes a starting timestamp of the input audio stream, and N denotes an ending timestamp of the input audio stream. For each code corresponding to a current timestamp Tₙ, the codes at Tₙ, Tₙ₋₁, Tₙ₋₂, Tₙ₋₃, Tₙ₋₄, Tₙ₋₅, . . . , T_{S} (e.g., current code 225 and past codes 226) may be a plurality of contextual codes that represent a context 228. The context 228 may be used by the disfluency code classifier 216 to predict whether the current code 225 or each of future codes 227 corresponds to normal speech or disfluent speech.

The disfluency code classifier 216 is configured to classify each code in the code vector 224 as a normal speech code or a disfluent speech code. In certain embodiments, the disfluency code classifier 216 determines a probability for each code in the code vector 224 as being disfluent speech or normal speech. For example, the disfluency code classifier 216 uses the context 228 of the current code 225 and the past codes 226 to predict whether the current code 225 or each of the future codes 227 corresponds to normal speech or disfluent speech. The size of the context 228 depends on how much latency is permitted. In certain embodiments, the size of the context 228 may range from 200 to 500 milliseconds, thus allowing the disfluency code classifier 216 to effectively distinguish between normal speech and disfluencies (e.g., differentiating “you” from “you know”). In certain embodiments, the disfluency code classifier 216 operates in an online setting. That is, for example, the disfluency code classifier 216 has a specific field-of-view of a predetermined number of codes (e.g., 300 codes, of which 299 are from the past and one is for last predicted code). Thus, the disfluency code classifier 216 trained for online or real-time applications can only see a limited context of past codes. In certain embodiments, the disfluency code classifier 216 operates in an offline setting or in a setting where the speech input length is limited (e.g., audio stream with short commands). In these settings, an expanded context, such as a combination of past and future codes or a full set of codes may be used to perform disfluency removal.

In certain embodiments, after determining the probability, the disfluency code classifier 216 compares the probability associated with the code to a predetermined threshold. If the probability exceeds a threshold, the disfluency code classifier 216 assigns a normal speech label (e.g., “1”) to the code. However, if the probability does not exceed the threshold, the disfluency code classifier 216 assigns a disfluent speech label (e.g., “0”) to the code. The threshold can be adjusted based on user requirement and/or feedback. Based on the labels corresponding to codes in the code vector 224, the disfluency code modifier 217 is configured to replace each code having the disfluent speech label (e.g., codes with the “0” label) with a code corresponding to silence (“silence code”) or a code corresponding to a replacement speech (“replacement speech code”).

For example, a silence code may correspond to a predetermined duration of silence (e.g., a frame of silence in an input audio stream). A replacement speech code may correspond to a frame of replacement speech (e.g., normal speech), which may include a stretched version of one or more previous words or syllables in the input audio stream. For example, the replacement speech includes at least one normal word immediately preceding a word of the disfluent speech that is being replaced. Moreover, the replacement speech may be speech content having the same meaning and duration as the disfluent speech that is being replaced.

The classification outputs (e.g., labels) and code vector 224 are provided as inputs to the disfluency code modifier 217. The disfluency code modifier 217, using the context 228, is configured to replace one or more disfluent speech codes in the code vector 224 with silence codes or normal speech codes to generate a modified code vector 230 including a current code corresponding to a current timestamp Tₙ and optionally a plurality of future codes corresponding to future timestamps Tₙ₊₁, Tₙ₊₂, Tₙ₊₃, Tₙ₊₄, Tₙ₊₅, . . . , T_{N}. Thus, the modified code vector 230 is a disfluency-free code stream that may be decoded, via a decoder (e.g., audio decoder 108 or any suitable decoder), to generate a disfluency-free output audio stream. In certain embodiments, the disfluency code modifier 217 may be trained to avoid long pauses of silence in the output audio stream by limiting the number of replacement of codes in the code vector 224 with silence code. Limitation of long silent pauses ensures the output audio stream exhibits the rhythm of natural speech, thereby providing a positive user experience.

The disfluency code classifier 216 and the disfluency code modifier 217 can be implemented in substantially the same manner as depicted by the system shown in FIG. 1. In certain embodiments, the disfluency code classifier 216 may be trained based on a plurality of labeled training data to classify and/or predict disfluency in a streaming fashion. Since each code (e.g., neural code) in a code vector representing an input audio stream corresponds to a frame of speech (e.g., a fixed period of speech such, as 10 or 20 milliseconds), there is a one-to-one correspondence between speech in the input audio stream and the codes as both correspond to the same timings (e.g., timestamps). Thus, the plurality of labeled training data may include a plurality of codes each corresponding to a label, such as a normal speech label (e.g., “1”), a disfluent speech label (e.g., “0”), or any suitable label. The disfluency code classifier 216 may be iteratively trained based on the plurality of labeled training data until a stopping criterion is met. For example, the stopping criterion may include a classification/prediction accuracy threshold (e.g., accuracy at 85% or higher), execution time, a number of iterations, or any suitable stopping criterion. The stopping criterion may be determined based on user requirement/preference and/or resource limitations. The classification/prediction accuracy may be determined by comparing a label assigned by the disfluency code classifier 216 to a code and an actual label associated with the code (e.g., ground truth label).

In certain embodiments, the plurality of labeled training data may be obtained based on a labeled speech disfluency dataset that includes speech examples and corresponding speech disfluency labels (e.g., normal speech or disfluent speech). In one example, the labeled speech disfluency dataset includes speech examples and labels identifying whether the speech example is a filler word. An encoder-decoder model may automatically annotate the labeled speech disfluency dataset with neural codes by using the frame timings (e.g., frame timestamps) in the audio stream from which the speech examples are extracted. Thus, the resulting annotated (e.g., labeled) data are a plurality of labeled training data that includes a plurality of pairs of codes (e.g., neural codes) and speech disfluency labels (e.g., normal speech or disfluent speech). In certain embodiments, voice-activity detection (VAD) and automatic speech recognition (ASR) may be used to identify and label voiced parts of speech that the ASR fails to transcribe accurately as disfluencies. Moreover, in certain embodiments, the labels can be assigned manually or using an automatic approach, which may involve distance matching or clustering approaches to determine codes that correspond to disfluent speech.

In certain embodiments, acoustic word embeddings may be used to annotate disfluencies (e.g., filler words). The word embeddings are obtained by training a metric network that correlates speech examples with speech targets (e.g., via techniques used in speaker verification). The resulting embeddings can be used to detect filler words by comparing the embeddings to a database of known filler words embeddings. This process can be made more robust by combining with ASR and VAD systems. Moreover, in certain embodiments, a corpus of sentences pairs with and without disfluencies can be created. The sentence pairs can be provided as input to a Text-to-Speech (TTS) system to generate speech outputs for each pair. By encoding both speech pairs, disfluency neural codes may be identified for those belonging only to the disfluent speech.

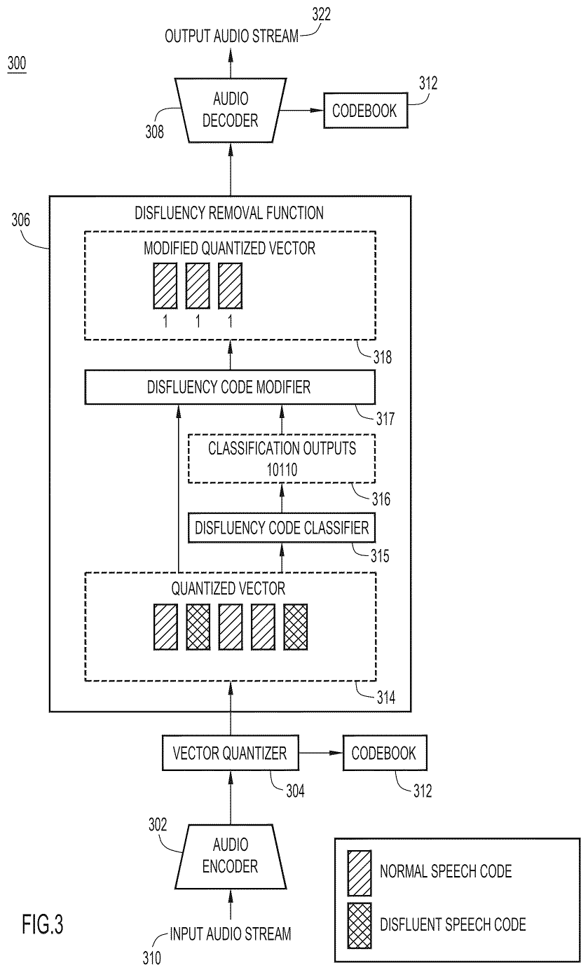

Reference is now made to FIG. 3, for a description of a block diagram illustrating a neural network audio encoder/decoder (codec) system 300, according to another example embodiment. Whereas the neural network audio codec system 100 of FIG. 1 replaces codes for disfluent speech, the neural network audio codec system 300 removes codes for disfluent speech. The neural network audio codec system 300 includes an audio encoder 302, a vector quantizer 304, a disfluency removal function 306, and an audio decoder 308. In certain embodiments, the audio encoder 302, the vector quantizer 304, and the audio decoder 308 are part of a Vector Quantized Variational Autoencoder.

The audio encoder 302 receives an input audio stream 310 that includes speech as well as artifacts and/or impairments. For example, the input audio stream 310 may be obtained from an audio recording, a video, and/or any suitable source. In one example, the input audio stream 310 may be obtained from recordings of audio and/or video meetings conducted on a collaboration platform. The input audio stream 310 includes one or more frames each corresponding to a predetermined duration of speech (e.g., 10 or 20 milliseconds). Each of the one or more frames may correspond to normal speech or disfluent speech.

In certain embodiments, the input audio stream 310 may include a combination of normal speech and disfluent speech. The audio encoder 302 encodes the input audio stream 310 to generate one or more embedding vectors including data that represent the important/meaningful features or relationships (e.g., temporal dependencies and/or patterns) of the input audio stream 310 in substantially the same manner as depicted by the system shown in FIG. 1. For example, the audio encoder 302 may include a deep neural network that transforms the input audio stream 310 frame-by-frame into one or more embedding vectors that keep the important features and optionally removing the artifacts and/or impairments. In certain embodiments, the audio encoder 302 may encode the input audio stream 310 in a streaming fashion (e.g., via stream processing).

The vector quantizer 304 quantizes the one or more embedding vectors at the output of the audio encoder 302. The vector quantizer 304 may quantize the one or more embedding vectors (e.g., high-dimensional embeddings vectors) by mapping the one or more embedding vectors into a set of codewords from a codebook 312 using one or more quantization techniques in substantially the same manner as depicted by the system shown in FIG. 1.

Each code (e.g., neural code) in the one or more quantized vectors corresponds to a frame of speech in the input audio stream 310. For example, each code in the quantized vector 314 is a code corresponding to a frame of normal speech (e.g., “normal speech code”) or a code corresponding to a frame of disfluent speech (e.g., “disfluent speech code). The one or more quantized vectors (e.g., quantized vector 314) are provided as input to the disfluency removal function 306. The disfluency removal function 306 includes a disfluency code classifier 315 configured to generate one or more classification outputs 316 each classifying a code as corresponding to normal speech or disfluent speech, and further includes a disfluency code modifier 317 configured to remove one or more codes corresponding to disfluent speech.

The disfluency code classifier 315 is configured to classify each code in the one or more quantized vectors as a normal speech code or a disfluent speech code in substantially the same manner as described above in FIG. 1. The one or more classification outputs 316 and the one or more quantized vectors (e.g., the quantized vector 314) are provided as inputs to the disfluency code modifier 317. Based on the one or more classification outputs 316, the disfluency code classifier 315 is configured to remove each code in the one or more quantized vectors (e.g., the quantized vector 314) having the disfluent speech label (e.g., codes with the “0” label). Thus, the disfluency code classifier 315 is configured to remove one or more disfluent speech codes in the one or more quantized vectors to generate one or more modified quantized vectors (e.g., a modified quantized vector 318) having only normal speech codes (e.g., codes with the “1” label).

For example, the input audio stream 310 may include speech for the sentence “We will discuss the report with your . . . um . . . team.” The disfluency code classifier 315 may classify the code corresponding to the speech “um” as a disfluent speech code and removes the code from the one or more quantized vectors, and the resulting one or more modified quantized vectors contain only normal speech codes. For example, the code corresponding to the disfluent speech “um” is removed from the quantized vector including codes corresponding to “We will discuss the report with your . . . um . . . team.” Thus, only codes corresponding to normal speech (e.g., “We will discuss the report with your team.”) remain in the one or more modified quantized vectors (e.g., a modified quantized vector 318).

The one or more modified quantized vectors are provided as input to the audio decoder 308. The audio decoder 308 is configured to decode the discrete codes in the one or more modified quantized vectors using a codebook 312 and reconstruct the input audio stream 310 without the disfluent speech in substantially the same manner as depicted by the system shown in FIG. 1. That is, for example, the audio decoder 308 is configured to generate an output audio stream 322 (e.g., the reconstructed input audio stream) that includes speech without disfluencies. In certain embodiments, the audio decoder 308 may generate the output audio stream 322 in a streaming fashion (e.g., via stream processing). In certain embodiments, instead of the codebook 312, the audio decoder 308 may use a different codebook, such as a codebook that includes all of the data in the codebook 312 and additional data suitable for decoding purposes.

In certain embodiments, the audio decoder 308 is configured to detect that two or more consecutive codes in a modified quantized vector (e.g., modified quantized vector 318) are the same, thus indicating the speech corresponding to those codes are stretched across two or more frames. Thus, the audio decoder 308 is configured to generate a smooth and continuous stretched audio output in those frames to mimic natural speech patterns without speech disfluencies. The output audio stream 322 may be provided as output to a user (e.g., via a user interface), a database, etc. Therefore, the neural network audio codec system 300 can be leveraged to improve the speech quality of audio outputs, thereby providing a positive listening experience for the user.

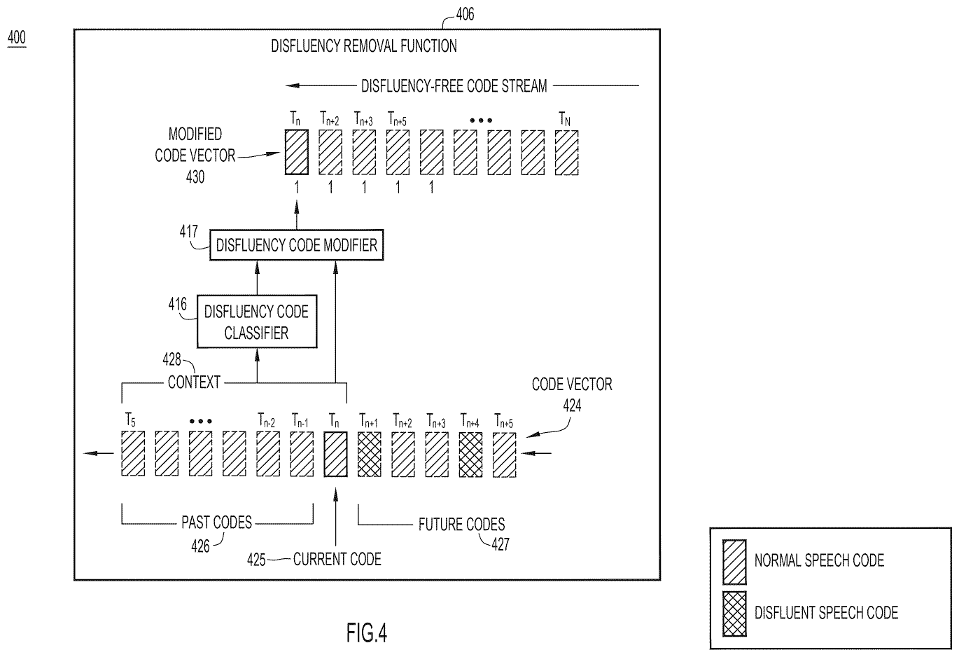

Reference is now made to FIG. 4, for a description of a block diagram illustrating a processing flow 400 for classifying a speech code and removing codes for disfluent speech as depicted in FIG. 3, but now in more detail, according to an example embodiment. The processing flow 400 includes operations performed by a disfluency removal function 406 configured to classify a code as corresponding to normal speech or disfluent speech and/or remove one or more codes corresponding to disfluent speech. The disfluency removal function 406 includes operations performed by a disfluency code classifier 416 and a disfluency code modifier 417. The disfluency code classifier 416 takes as input a code vector 424 (e.g., a quantized vector) having a plurality of codes (e.g., neural codes) each corresponding to a frame of speech from an input audio stream. For example, a code may correspond to a frame of normal speech (e.g., “normal speech code”) or to a frame of disfluent speech (e.g., “disfluent speech code). Each frame may be a predetermined duration of speech (e.g., 10 or 20 milliseconds). In certain embodiments, the code vector 424 may be generated by a vector quantizer (e.g., vector quantizer 304) configured to map one or more embedding vectors representing an input audio stream to one or more quantized vectors of discrete codes.

For example, the code vector 424 includes a plurality of codes each corresponding to a frame of speech at time T of the input audio stream. For example, the code vector 424 may contain a current code 425 corresponding to a current timestamp Tₙ, a plurality of past codes 426 corresponding to past timestamps Tₙ₋₁, Tₙ₋₂, Tₙ₋₃, Tₙ₋₄, Tₙ₋₅, . . . , T_{S}, and a plurality of future codes 427 corresponding to future timestamps Tₙ₊₁, Tₙ₊₂, Tₙ₊₃, Tₙ₊₄, Tₙ₊₅, . . . , T_{N}, where n denotes a current timestamp of the input audio stream, S denotes a starting timestamp of the input audio stream, and N denotes an ending timestamp of the input audio stream. For each code corresponding to a current timestamp Tₙ, the codes at Tₙ, Tₙ₋₁, Tₙ₋₂, Tₙ₋₃, Tₙ₋₄, Tₙ₋₅, . . . , T_{S} (e.g., current code 425 and past codes 426) may be a plurality of contextual codes that represent a context 428. The context 428 that may be used by the disfluency code classifier 416 to predict whether the current code 425 or each of the future codes 427 corresponds to normal speech or disfluent speech.

The disfluency code classifier 416 is configured to classify each code in the code vector 424 as a normal speech code or a disfluent speech code. In certain embodiments, the disfluency code classifier 416 determines a probability for each code in the code vector 424 as being disfluent speech or normal speech. For example, the disfluency code classifier 416 uses the context 428 of the current code 425 and the past codes 426 to predict whether the current code 425 or each of the future codes 427 corresponds to normal speech or disfluent speech. The size of the context 428 depends on how much latency is permitted. In certain embodiments, the size of the context 428 may range from 200 to 500 milliseconds, thus allowing the disfluency code classifier 416 to effectively distinguish between normal speech and disfluencies (e.g., differentiating “you” from “you know”). In certain embodiments, the disfluency code classifier 416 operates in an online setting. That is, for example, the disfluency code classifier 416 has a specific field-of-view of a predetermined number of codes (e.g., 300 codes, of which 299 are from the past and one is for last predicted code). Thus, the disfluency code classifier 416 trained for online or real-time applications can only see a limited context of past codes. In certain embodiments, the disfluency code classifier 416 operates in an offline setting or in a setting where the speech input length is limited (e.g., audio stream with short commands). In these settings, an expanded context, such as a combination of past and future codes or a full set of codes may be used to perform disfluency removal.

In certain embodiments, after determining the probability, the disfluency code classifier 416 compares the probability associated with the code to a predetermined threshold. If the probability exceeds a threshold, the disfluency code classifier 416 assigns a normal speech label (e.g., “1”) to the code. However, if the probability does not exceed the threshold, the disfluency code classifier 416 assigns a disfluent speech label (e.g., “0”) to the code. The threshold can be adjusted based on user requirement and/or feedback. The classification outputs (e.g., labels) and code vector 424 are provided as inputs to the disfluency code modifier 417. Based on the labels corresponding to codes in the code vector 424, the disfluency code modifier 417 is configured to remove each code having the disfluent speech label (e.g., codes with the “0” label). Thus, the disfluency code modifier 417, using the context 428, is configured to generate a modified code vector 430 including a current code corresponding to a current timestamp Tₙ if the current code corresponds to a normal speech label and optionally a plurality of future codes that correspond to the normal speech label (e.g., “1”). In one example, the disfluency code classifier 416 may classify that a subset of futures codes 427 corresponds to the disfluent speech label (e.g., future codes corresponding to timestamps Tₙ₊₁ and Tₙ₊₄). Then, the disfluency code modifier 417 may remove the future codes corresponding to timestamps Tₙ₊₁ and Tₙ₊₄ from the code vector 424. The modified code vector 430 may include only codes that correspond to the normal speech label, such as codes corresponding to timestamps Tₙ, Tₙ₊₂, Tₙ₊₃, Tₙ₊₅, . . . , T_{N}. Thus, the modified code vector 430 is a disfluency-free code stream that may be decoded, via a decoder (e.g., audio decoder 308), to generate a disfluency-free output audio stream.

The disfluency code classifier 416 and the disfluency code modifier 417 can be implemented in substantially the same manner as depicted by the system shown in FIG. 3. In certain embodiments, the disfluency code classifier 416 may be trained based on a plurality of labeled training data to classify and/or predict disfluency in a streaming fashion. Since each code (e.g., neural code) in a code vector representing an input audio stream corresponds to a frame of speech (e.g., a fixed period of speech such as 10 or 20 milliseconds), there is a one-to-one correspondence between speech in the input audio stream and the codes as both correspond to the same timings (e.g., timestamps). Thus, the plurality of labeled training data may include a plurality of codes each corresponding to a label, such as a normal speech label (e.g., “1”), a disfluent speech label (e.g., “0”), or any suitable label. The disfluency code classifier 416 may be iteratively trained based on the plurality of labeled training data until a stopping criterion is met. For example, the stopping criterion may include a classification/prediction accuracy threshold (e.g., accuracy at 85% or higher), execution time, a number of iterations, or any suitable stopping criterion. The stopping criterion may be determined based on user requirement/preference and/or resource limitations. The classification/prediction accuracy may be determined by comparing a label assigned by the disfluency code classifier 416 to a code and an actual label associated with the code (e.g., ground truth label). In certain embodiments, the plurality of labeled training data may be obtained based on a labeled speech disfluency dataset in substantially the same manner as described above.

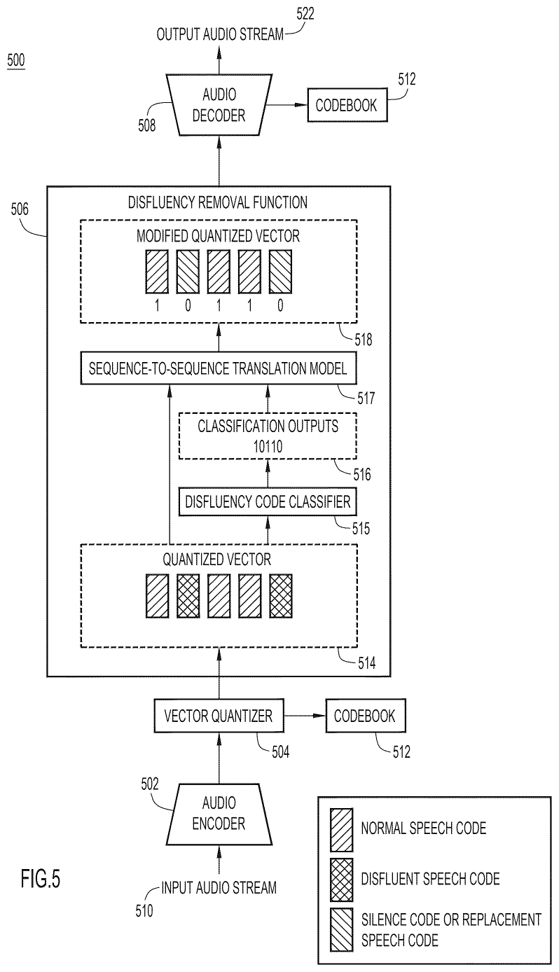

Reference is first made to FIG. 5, for a description of a block diagram illustrating a neural network audio encoder/decoder (codec) system 500, according to yet another example embodiment. The neural network audio codec system 500 includes an audio encoder 502, a vector quantizer 504, a disfluency removal function 506, and an audio decoder 508. In certain embodiments, the audio encoder 502, the vector quantizer 504, and the audio decoder 508 are part of a Vector Quantized Variational Autoencoder.

The audio encoder 502 receives an input audio stream 510 that includes speech as well as artifacts and/or impairments. For example, the input audio stream 510 may be obtained from an audio recording, a video, and/or any suitable source. In one example, the input audio stream 510 may be obtained from recordings of audio and/or video meetings conducted on a collaboration platform. The input audio stream 510 includes one or more frames each corresponding to a predetermined duration of speech (e.g., 10 or 20 milliseconds). Each of the one or more frames may correspond to normal speech or disfluent speech.

In certain embodiments, the input audio stream 510 may include a combination of normal speech and disfluent speech. The audio encoder 502 encodes the input audio stream 510 to generate one or more embedding vectors including data that represent the important features or relationships (e.g., temporal dependencies and/or patterns) of the input audio stream 510 in substantially the same manner as depicted by the system shown in FIG. 1. For example, the audio encoder 502 may include a deep neural network that transforms the input audio stream 510 frame-by-frame into one or more embedding vectors that keep the important features and optionally removing the artifacts and/or impairments. In certain embodiments, the audio encoder 502 may encode the input audio stream 510 in a streaming fashion (e.g., via stream processing).

The vector quantizer 504 quantizes the one or more embedding vectors at the output of the audio encoder 502. The vector quantizer 504 may quantize the one or more embedding vectors (e.g., high-dimensional embeddings vectors) by mapping the one or more embedding vectors into a set of codewords from a codebook 512 using one or more quantization techniques in substantially the same manner as depicted by the system shown in FIG. 1.

Each code (e.g., neural code) in the one or more quantized vectors corresponds to a frame of speech in the input audio stream 510. For example, each code in the quantized vector 514 is a code corresponding to a frame of normal speech (e.g., “normal speech code”) or a code corresponding to a frame of disfluent speech (e.g., “disfluent speech code). The one or more quantized vectors (e.g., quantized vector 514) are provided as input to the disfluency removal function 506. The disfluency removal function 506 includes a disfluency code classifier 515 configured to generate one or more classification outputs 516 each classifying a code as corresponding to normal speech or disfluent speech, and further includes a sequence-to-sequence (STS) translation model 517 configured to translate a sequence of codes (e.g., codes in the quantized vector 514) containing disfluency to a sequence without any disfluency.

The disfluency code classifier 515 and/or the STS translation model 517 can be implemented via a neural network (e.g., feed-forward deep neural network, convolutional neural network, recurrent neural network, etc.), a support vector machine, a transformer-based model (e.g., large language model), a hybrid model including multiple machine learning models, or any suitable machine learning model. The disfluency code classifier 515 and/or the STS translation model 517 may be trained, optimized, and/or fine-tuned via any suitable technique (e.g., supervised or unsupervised learning, transfer learning, reinforcement learning, etc.). In certain embodiments, the disfluency code classifier 515 and the STS translation model 517 may be trained separately. For example, the STS translation model 517 may be trained after the disfluency code classifier 515 has been trained.

In certain embodiments, the disfluency code classifier 515 and/or the STS translation model 517 may be trained based on a plurality of labeled training data to classify and/or predict disfluency in a streaming fashion. Since each code (e.g., neural code) in a code vector representing an input audio stream corresponds to a frame of speech (e.g., a fixed period of speech such as 10 or 20 milliseconds), there is a one-to-one correspondence between speech in the input audio stream and the codes as both correspond to the same timings (e.g., timestamps). Thus, the plurality of labeled training data may include a plurality of codes each corresponding to a label, such as a normal speech label (e.g., “1”), a disfluent speech label (e.g., “0”), or any suitable label. The disfluency code classifier 515 and/or the STS translation model 517 may be iteratively trained based on the plurality of labeled training data until a stopping criterion is met. For example, the stopping criterion may include a classification/prediction accuracy threshold (e.g., accuracy at 85% or higher), execution time, a number of iterations, or any suitable stopping criterion. The stopping criterion may be determined based on user requirement/preference and/or resource limitations. The classification/prediction accuracy may be determined by comparing a predicted label assigned to a code and an actual label associated with the code (e.g., ground truth label). In certain embodiments, the plurality of labeled training data may be obtained based on a corpus of sentence pairs. For example, a corpus of sentences pairs with and without disfluencies can be created. The sentence pairs can be provided as input to a Text-to-Speech (TTS) system to generate speech outputs for each pair. By encoding both speech pairs, disfluency neural codes may be identified for those belonging only to the disfluent speech.

The disfluency code classifier 515 is configured to classify each code in the one or more quantized vectors as a normal speech code or a disfluent speech code. In certain embodiments, the disfluency code classifier 515 determines a probability for each code in the one or more quantized vectors as being disfluent speech or normal speech. Then, the disfluency code classifier 515 compares the probability associated with the code to a predetermined threshold. If the probability exceeds a threshold, the disfluency code classifier 515 assigns a normal speech label (e.g., “1”) to the code. However, if the probability does not exceed the threshold, the disfluency code classifier 515 assigns a disfluent speech label (e.g., “0”) to the code. The threshold can be adjusted based on user requirement and/or feedback. The labels (e.g., “1” for normal speech label or “0” for disfluent speech label) corresponding to the one or more codes may be provided as the one or more classification outputs 516 to the STS translation model 517. In certain embodiments, the one or more classification outputs 516 may include probability values corresponding to the one or more codes in the one or more quantized vectors as being disfluent speech or normal speech.

The one or more classification outputs 516 and the one or more quantized vectors (e.g., the quantized vector 514) are provided as inputs to the STS translation model 517. Based on the one or more classification outputs 516, the STS translation model 517 is configured to translate a sequence of codes (e.g., codes in the quantized vector 514) containing disfluency to a sequence without any disfluency by replacing each code in the one or more quantized vectors having the disfluent speech label (e.g., codes with the “0” label) with a code corresponding to silence (“silence code”) or a code corresponding to a replacement speech (“replacement speech code”). For example, a silence code may correspond to a predetermined duration of silence (e.g., a frame of silence in an input audio stream). A replacement speech code may correspond to a frame of replacement speech (e.g., normal speech), which may include a stretched version or slowed down version of one or more previous words or syllables in the input audio stream 510. For example, the replacement speech includes at least one normal word immediately preceding a word of the disfluent speech that is being replaced. Moreover, the replacement speech may be speech content having the same meaning and duration as the disfluent speech that is being replaced. The STS translation model 517 is configured to replace one or more disfluent speech codes in the one or more quantized vectors with silence codes or normal speech codes to generate one or more modified quantized vectors (e.g., a modified quantized vector 518) without any disfluent speech codes. In certain embodiments, the STS translation model 517 is configured to translate a sequence of codes (e.g., codes in the quantized vector 514) containing disfluency to a sequence without any disfluency by replacing all codes in the one or more quantized vectors with new codes corresponding to replacement speech having the same meaning and duration as the speech that is being replaced.

The one or more modified quantized vectors are provided as input to the audio decoder 508. The audio decoder 508 is configured to decode the discrete codes in the one or more modified quantized vectors using a codebook 512 and reconstructs the input audio stream 510 without the disfluent speech in substantially the same manner as depicted by the system shown in FIG. 1. That is, for example, the audio decoder 508 is configured to generate an output audio stream 522 (e.g., the reconstructed input audio stream) that includes speech without disfluencies. In certain embodiments, the audio decoder 108 may generate the output audio stream 522 in a streaming fashion (e.g., via stream processing). In certain embodiments, instead of the codebook 512, the audio decoder 508 may use a different codebook, such as a codebook that includes all of the data in the codebook 512 and additional data suitable for decoding purposes.

In certain embodiments, the audio decoder 508 is configured to detect that two or more consecutive codes in a modified quantized vector (e.g., modified quantized vector 518) are the same, thus indicating the speech corresponding to those codes are stretched across two or more frames. Thus, the audio decoder 508 is configured to generate a smooth and continuous stretched audio output in those frames to mimic natural speech patterns without speech disfluencies. The output audio stream 522 may be provided as output to a user (e.g., via a user interface), a database, etc. Therefore, the neural network audio codec system 500 can be leveraged to improve the speech quality of audio outputs, thereby providing a positive listening experience for the user.

In certain embodiments, the audio encoder 502, the disfluency code classifier 515, and the audio decoder 508 are trained together in an end-to-end manner to remove speech disfluencies from an input audio stream (e.g., input audio stream 510). In certain embodiments, the disfluency code classifier 515 and/or the STS translation model 517 may be trained separately from the audio encoder 502 and the audio decoder 508 (e.g., an encoder-decoder pair). In these embodiments, the discrete codes (e.g., neural codes) and corresponding labels used by the audio encoder 502 and the audio decoder 508 may be known to the disfluency code classifier 515 prior to training, thus making it easier to label each code as corresponding to normal speech or disfluency. In some examples, the disfluency code classifier 515 and/or the STS translation model 517 may be trained after the audio encoder 502 and the audio decoder 508 are trained.

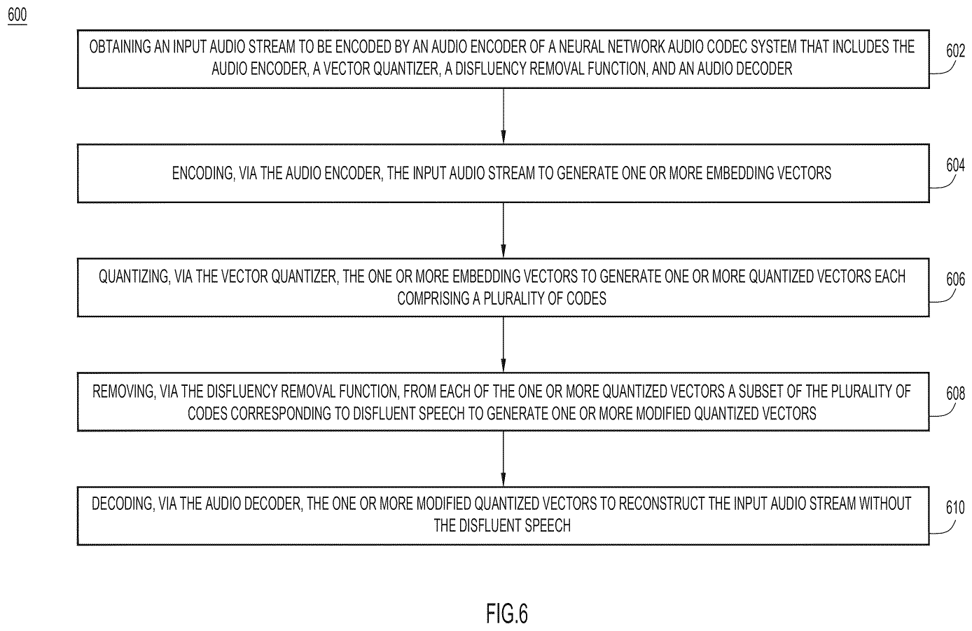

FIG. 6 is a flow diagram illustrating a method 600 for removing disfluent speech from an input audio stream, according to an example embodiment.

At 602, the method 600 involves obtaining an input audio stream to be encoded by an audio encoder of a neural network audio codec system that includes the audio encoder, a vector quantizer, a disfluency removal function, and an audio decoder.

At 604, the method 600 involves encoding, via the audio encoder, the input audio stream to generate one or more embedding vectors.

At 606, the method 600 involves quantizing, via the vector quantizer, the one or more embedding vectors to generate one or more quantized vectors each comprising a plurality of codes.

At 608, the method 600 involves removing, via the disfluency removal function, from each of the one or more quantized vectors a subset of the plurality of codes corresponding to disfluent speech to generate one or more modified quantized vectors.

At 610, the method 600 involves decoding, via the audio decoder, the one or more modified quantized vectors to reconstruct the input audio stream without the disfluent speech.

In the method 600, wherein the audio encoder, the vector quantizer, and the audio decoder are part of a Vector Quantized Variational Autoencoder.

In the method 600, removing further involves classifying each code in the one or more quantized vectors as being disfluent speech or normal speech, and replacing the subset of the plurality of codes corresponding to disfluent speech with one or more codes corresponding to silence or a replacement speech.

In the method 600, classifying further involves determining a probability for each code in the one or more quantized vectors as being disfluent speech or normal speech, and classifying each code in the one or more quantized vectors as being disfluent speech or normal speech based on the probability.

In the method 600, wherein the one or more codes corresponding to the replacement speech include one or more codes corresponding to at least one normal word immediately preceding a word of the disfluent speech that is being replaced.

In the method 600, classifying each code in the one or more quantized vectors as being disfluent speech or normal speech based on the probability further involves determining a probability for each code in the one or more quantized vectors as being disfluent speech or normal speech, and classifying each code in the one or more quantized vectors as being disfluent speech or normal speech based on the probability.

In the method 600, removing further involves classifying each code in the one or more quantized vectors as being disfluent speech or normal speech, and removing the subset of the plurality of codes corresponding to disfluent speech.

In the method 600, wherein the disfluent speech includes one or more filler words, one or more filler syllables of one or more words, or a predetermined duration of silence.

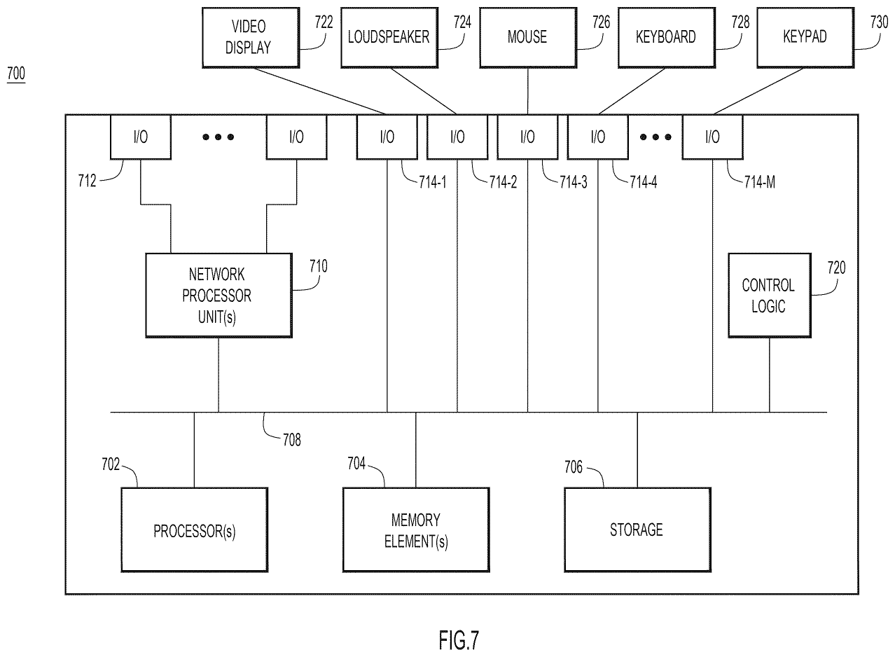

Referring to FIG. 7, FIG. 7 illustrates a hardware block diagram of a computing device 700 that may perform functions associated with operations discussed herein in connection with the techniques depicted in FIGS. 1-6. In various embodiments, a computing device or apparatus, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714-1, 714-2, 714-3, 714-4, . . . , 714-M, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714-1 to 714-M allow for input and output of data and/or information with other entities that may be connected to computing device 700. For example, I/O interface(s) 714-1 to 714-M may provide a connection to external devices such as a video display (e.g., touch-screen display) 722, loudspeaker 724, mouse 726, keyboard 728, keypad 730, and/or any other suitable input and/or output device now known or hereafter developed. It is also envisioned that many of these external devices may be integrated as part of the computing device 700. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: obtaining an input audio stream to be encoded by an audio encoder of a neural network audio codec system that includes the audio encoder, a vector quantizer, a disfluency removal function, and an audio decoder; encoding, via the audio encoder, the input audio stream to generate one or more embedding vectors; quantizing, via the vector quantizer, the one or more embedding vectors to generate one or more quantized vectors each including a plurality of codes; removing, via the disfluency removal function, from each of the one or more quantized vectors a subset of the plurality of codes corresponding to disfluent speech to generate one or more modified quantized vectors; and decoding, via the audio decoder, the one or more modified quantized vectors to reconstruct the input audio stream without the disfluent speech.

In some aspects, the techniques described herein relate to a method, wherein the audio encoder, the vector quantizer, and the audio decoder are part of a Vector Quantized Variational Autoencoder.

In some aspects, the techniques described herein relate to a method, wherein removing includes: classifying each code in the one or more quantized vectors as being disfluent speech or normal speech; and replacing the subset of the plurality of codes corresponding to disfluent speech with one or more codes corresponding to silence or a replacement speech.

In some aspects, the techniques described herein relate to a method, wherein classifying includes: determining a probability for each code in the one or more quantized vectors as being disfluent speech or normal speech; and classifying each code in the one or more quantized vectors as being disfluent speech or normal speech based on the probability.

In some aspects, the techniques described herein relate to a method, wherein the one or more codes corresponding to the replacement speech include one or more codes corresponding to at least one normal word immediately preceding a word of the disfluent speech that is being replaced.

In some aspects, the techniques described herein relate to a method, wherein classifying each code in the one or more quantized vectors as being disfluent speech or normal speech based on the probability includes: determining a probability for each code in the one or more quantized vectors as being disfluent speech or normal speech; and classifying each code in the one or more quantized vectors as being disfluent speech or normal speech based on the probability.

In some aspects, the techniques described herein relate to a method, wherein removing includes: classifying each code in the one or more quantized vectors as being disfluent speech or normal speech; and removing the subset of the plurality of codes corresponding to disfluent speech.

In some aspects, the techniques described herein relate to a method, wherein the disfluent speech includes one or more filler words, one or more filler syllables of one or more words, or a predetermined duration of silence.

In some aspects, the techniques described herein relate to a method, wherein removing includes: classifying each code in the one or more quantized vectors as being disfluent speech or normal speech; and translating the plurality of codes in the one or more quantized vectors into a second plurality of codes that correspond to speech without disfluency.

In some aspects, the techniques described herein relate to an apparatus including: a memory; and one or more processors coupled to the memory, wherein the one or more processors are configured to perform operations including: obtaining an input audio stream to be encoded by an audio encoder of a neural network audio codec system that includes the audio encoder, a vector quantizer, a disfluency removal function, and an audio decoder; encoding, via the audio encoder, the input audio stream to generate one or more embedding vectors; quantizing, via the vector quantizer, the one or more embedding vectors to generate one or more quantized vectors each including a plurality of codes; and removing, via the disfluency removal function, from each of the one or more quantized vectors a subset of the plurality of codes corresponding to disfluent speech to generate one or more modified quantized vectors for use by the audio decoder in reconstructing the input audio stream without the disfluent speech.

In some aspects, the techniques described herein relate to an apparatus, wherein the audio encoder, the vector quantizer, and the audio decoder are part of a Vector Quantized Variational Autoencoder.

In some aspects, the techniques described herein relate to an apparatus, wherein removing includes: classifying each code in the one or more quantized vectors as being disfluent speech or normal speech; and replacing the subset of the plurality of codes corresponding to disfluent speech with one or more codes corresponding to silence or a replacement speech.

In some aspects, the techniques described herein relate to an apparatus, wherein classifying includes: determining a probability for each code in the one or more quantized vectors as being disfluent speech or normal speech; and classifying each code in the one or more quantized vectors as being disfluent speech or normal speech based on the probability.

In some aspects, the techniques described herein relate to an apparatus, wherein the one or more codes corresponding to the replacement speech include one or more codes corresponding to at least one normal word immediately preceding a word of the disfluent speech that is being replaced.

In some aspects, the techniques described herein relate to an apparatus, wherein classifying each code in the one or more quantized vectors as being disfluent speech or normal speech based on the probability includes: determining a probability for each code in the one or more quantized vectors as being disfluent speech or normal speech; and classifying each code in the one or more quantized vectors as being disfluent speech or normal speech based on the probability.

In some aspects, the techniques described herein relate to an apparatus, wherein removing includes: classifying each code in the one or more quantized vectors as being disfluent speech or normal speech; and removing the subset of the plurality of codes corresponding to disfluent speech.

In some aspects, the techniques described herein relate to an apparatus, wherein the disfluent speech includes one or more filler words, one or more filler syllables of one or more words, or a predetermined duration of silence.

In some aspects, the techniques described herein relate to one or more non-transitory computer readable storage media encoded with instructions that, when executed by a processor, cause the processor to: obtain an input audio stream to be encoded by an audio encoder of a neural network audio codec system that includes the audio encoder, a vector quantizer, a disfluency removal function, and an audio decoder; encode, via the audio encoder, the input audio stream to generate one or more embedding vectors; quantize, via the vector quantizer, the one or more embedding vectors to generate one or more quantized vectors each including a plurality of codes; and remove, via the disfluency removal function, from each of the one or more quantized vectors a subset of the plurality of codes corresponding to disfluent speech to generate one or more modified quantized vectors for use by the audio decoder in reconstructing the input audio stream without the disfluent speech.

In some aspects, the techniques described herein relate to one or more non-transitory computer readable storage media, wherein the instructions are operable to cause the processor to remove, via the disfluency removal function, from each of the one or more quantized vectors a subset of the plurality of codes corresponding to disfluent speech to generate one or more modified quantized vectors by: classifying each code in the one or more quantized vectors as being disfluent speech or normal speech; and replacing the subset of the plurality of codes corresponding to disfluent speech with one or more codes corresponding to silence or a replacement speech.

In some aspects, the techniques described herein relate to one or more non-transitory computer readable storage media, wherein the instructions are operable to cause the processor to remove, via the disfluency removal function, from each of the one or more quantized vectors a subset of the plurality of codes corresponding to disfluent speech to generate one or more modified quantized vectors by: classifying each code in the one or more quantized vectors as being disfluent speech or normal speech; and removing the subset of the plurality of codes corresponding to disfluent speech.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining an input audio stream to be encoded by an audio encoder of a neural network audio codec system that includes the audio encoder, a vector quantizer, a disfluency removal function, and an audio decoder;
encoding, via the audio encoder, the input audio stream to generate one or more embedding vectors;
quantizing, via the vector quantizer, the one or more embedding vectors to generate one or more quantized vectors each comprising a plurality of codes;
removing, via the disfluency removal function, from each of the one or more quantized vectors a subset of the plurality of codes corresponding to disfluent speech to generate one or more modified quantized vectors; and
decoding, via the audio decoder, the one or more modified quantized vectors to reconstruct the input audio stream without the disfluent speech.

2. The method of claim 1, wherein the audio encoder, the vector quantizer, and the audio decoder are part of a Vector Quantized Variational Autoencoder.

3. The method of claim 1, wherein removing comprises:
classifying each code in the one or more quantized vectors as being disfluent speech or normal speech; and
replacing the subset of the plurality of codes corresponding to disfluent speech with one or more codes corresponding to silence or a replacement speech.

4. The method of claim 3, wherein classifying comprises:
determining a probability for each code in the one or more quantized vectors as being disfluent speech or normal speech; and
classifying each code in the one or more quantized vectors as being disfluent speech or normal speech based on the probability.

5. The method of claim 3, wherein the one or more codes corresponding to the replacement speech include one or more codes corresponding to at least one normal word immediately preceding a word of the disfluent speech that is being replaced.

6. The method of claim 4, wherein classifying each code in the one or more quantized vectors as being disfluent speech or normal speech based on the probability comprises:
determining a probability for each code in the one or more quantized vectors as being disfluent speech or normal speech; and
classifying each code in the one or more quantized vectors as being disfluent speech or normal speech based on the probability.

7. The method of claim 1, wherein removing comprises:
classifying each code in the one or more quantized vectors as being disfluent speech or normal speech; and
removing the subset of the plurality of codes corresponding to disfluent speech.

8. The method of claim 1, wherein the disfluent speech includes one or more filler words, one or more filler syllables of one or more words, or a predetermined duration of silence.

9. The method of claim 1, wherein removing comprises:
classifying each code in the one or more quantized vectors as being disfluent speech or normal speech; and
translating the plurality of codes in the one or more quantized vectors into a second plurality of codes that correspond to speech without disfluency.

10. An apparatus comprising:
a memory; and
one or more processors coupled to the memory, wherein the one or more processors are configured to perform operations including:
obtaining an input audio stream to be encoded by an audio encoder of a neural network audio codec system that includes the audio encoder, a vector quantizer, a disfluency removal function, and an audio decoder;
encoding, via the audio encoder, the input audio stream to generate one or more embedding vectors;
quantizing, via the vector quantizer, the one or more embedding vectors to generate one or more quantized vectors each comprising a plurality of codes; and
removing, via the disfluency removal function, from each of the one or more quantized vectors a subset of the plurality of codes corresponding to disfluent speech to generate one or more modified quantized vectors for use by the audio decoder in reconstructing the input audio stream without the disfluent speech.

11. The apparatus of claim 10, wherein the audio encoder, the vector quantizer, and the audio decoder are part of a Vector Quantized Variational Autoencoder.

12. The apparatus of claim 10, wherein removing comprises:
classifying each code in the one or more quantized vectors as being disfluent speech or normal speech; and
replacing the subset of the plurality of codes corresponding to disfluent speech with one or more codes corresponding to silence or a replacement speech.

13. The apparatus of claim 12, wherein classifying comprises:
determining a probability for each code in the one or more quantized vectors as being disfluent speech or normal speech; and
classifying each code in the one or more quantized vectors as being disfluent speech or normal speech based on the probability.

14. The apparatus of claim 12, wherein the one or more codes corresponding to the replacement speech include one or more codes corresponding to at least one normal word immediately preceding a word of the disfluent speech that is being replaced.

15. The apparatus of claim 13, wherein classifying each code in the one or more quantized vectors as being disfluent speech or normal speech based on the probability comprises:
determining a probability for each code in the one or more quantized vectors as being disfluent speech or normal speech; and
classifying each code in the one or more quantized vectors as being disfluent speech or normal speech based on the probability.

16. The apparatus of claim 10, wherein removing comprises:
classifying each code in the one or more quantized vectors as being disfluent speech or normal speech; and
removing the subset of the plurality of codes corresponding to disfluent speech.

17. The apparatus of claim 10, wherein the disfluent speech includes one or more filler words, one or more filler syllables of one or more words, or a predetermined duration of silence.

18. One or more non-transitory computer readable storage media encoded with instructions that, when executed by a processor, cause the processor to:
obtain an input audio stream to be encoded by an audio encoder of a neural network audio codec system that includes the audio encoder, a vector quantizer, a disfluency removal function, and an audio decoder;
encode, via the audio encoder, the input audio stream to generate one or more embedding vectors;
quantize, via the vector quantizer, the one or more embedding vectors to generate one or more quantized vectors each comprising a plurality of codes; and
remove, via the disfluency removal function, from each of the one or more quantized vectors a subset of the plurality of codes corresponding to disfluent speech to generate one or more modified quantized vectors for use by the audio decoder in reconstructing the input audio stream without the disfluent speech.

19. The one or more non-transitory computer readable storage media of claim 18, wherein the instructions are operable to cause the processor to remove, via the disfluency removal function, from each of the one or more quantized vectors a subset of the plurality of codes corresponding to disfluent speech to generate one or more modified quantized vectors by:
classifying each code in the one or more quantized vectors as being disfluent speech or normal speech; and
replacing the subset of the plurality of codes corresponding to disfluent speech with one or more codes corresponding to silence or a replacement speech.

20. The one or more non-transitory computer readable storage media of claim 18, wherein the instructions are operable to cause the processor to remove, via the disfluency removal function, from each of the one or more quantized vectors a subset of the plurality of codes corresponding to disfluent speech to generate one or more modified quantized vectors by:
classifying each code in the one or more quantized vectors as being disfluent speech or normal speech; and
removing the subset of the plurality of codes corresponding to disfluent speech.
